(19) United States
(12) Patent Application Publication
(10) Pub. No.: US 2007/0101019 A1
(43) Pub. Date: May 3, 2007

(54) Apparatus, system, and method for managing response latency

(76) Inventors: Daryl C. Cromer, Apex, NC (US); Howard J. Locker, Cary, NC (US); Randall S. Springfield, Chapel Hill, NC (US); Rod D. Waltermann, Rougemont, NC (US)

Correspondence Address: KUNZLER & ASSOCIATES, 8 EAST BROADWAY, SUITE 600, SALT LAKE CITY, UT, 84111, US

(21) Appl. No.: 11/266,036

(22) Filed: Nov. 3, 2005

(51) Int. Cl. G06F 15/173

(52) U.S. Cl. 709/238

(57) ABSTRACT

An apparatus, system, and method are disclosed for managing response latency. An identification module identifies a computation module that may communicate with a client through one or more communication modules. A calculation module calculates the number of communication modules that transceive a packet between the computation module and the client as a hop count. An association module associates the client with the first computation module in response to the hop count satisfying a count range of a response policy. In one embodiment, a trouble ticket module generates a trouble ticket in response to a specified number of clients having a hop count greater than the count range.

### BACKGROUND OF THE INVENTION

1. Field of the Invention

This invention relates to managing response latency and more particularly relates to managing response latency when associating a client with a remote computation module.

2. Description of the Related Art

A data processing device such as a computer workstation, a terminal, a server, a mainframe computer, or the like, herein referred to as a client, may often employ a remote computation module to execute one or more software processes. The computation module may be a server or the like. The server may be configured as a blade server, a modular server with one or more processors, memory, and communication capabilities residing in blade center. The blade center may be an enclosure such as a rack-mounted chassis with a plurality of other blade servers. The blade center may include data storage devices, data storage system interfaces, and communication interfaces. A data center may include a plurality of blade centers.

The computation module and the client may communicate by exchanging data packets referred to herein as packets. Packets may be communicated between the computation module and the client through one or more communication modules. Each packet includes a destination address and one or more data fields comprising transmission information, instructions, and data. A communication module may receive the packet from the computation module or the client and transmit the packet toward the packet's destination address. One or more communication modules may transceive each packet communicated between the computation module and the client.

The client may communicate a request or beacon to one or more data centers requesting association with a data center computation module. A data center may respond to the beacon if the data center includes a computation module with sufficient processing bandwidth to support the client. When associated with the client, the computation module may execute one or more software processes for the client.

Unfortunately, although the computation module may have sufficient processing bandwidth for the client, the input/output (“I/O”) response latency may still be excessive. I/O response latency, referred to herein as response latency, is a time required for an input message to pass the computation module and a response message to return from the client and the computation module. For example, a first data center may include a computation module with ample spare processing bandwidth to support the client. Yet the communications between the computation module and the client may be so delayed by the repeated transceiving of packets by a plurality of communication modules that communications between the client and the computation module are severely degraded. Thus a computation module with sufficient processing bandwidth may not provide adequate service to a client because of long response latency.

Response latency may be difficult to measure. For example, measuring response latency may require synchronized clocks at both the device transmitting a packet and the device receiving the packet. In addition, measurements of response latency often vary with the communications load of the communication modules, resulting in response latency measurements that vary from instance to instance.

From the foregoing discussion, it should be apparent that a need exists for an apparatus, system, and method that manage the response latency for a computation module associating with a client using a reliable response latency measurement. Beneficially, such an apparatus, system, and method would associate the client to the computation module that will provide an expected service level to the client.

### SUMMARY OF THE INVENTION

The present invention has been developed in response to the present state of the art, and in particular, in response to the problems and needs in the art that have not yet been fully solved by currently available response latency management methods. Accordingly, the present invention has been developed to provide an apparatus, system, and method for managing response latency that overcome many or all of the above-discussed shortcomings in the art.

The apparatus to manage response latency is provided with a logic unit containing a plurality of modules configured to functionally execute the necessary steps of identifying a computation module, calculating the number of communications module that transceive a packet, and associating the client. These modules in the described embodiments include an identification module, a calculation module, and an association module.

The identification module identifies a computation module. The computation module may be a target for association with a client. In one embodiment, the client communicates a beacon requesting association with a computation module. The identification module may identify the computation module as having spare processing bandwidth sufficient to support the client.

The calculation module calculates the number of communication modules that transceive a packet between the computation module and the client. The number of communication modules transceiving the packet is referred to herein as a hop count. The hop count may be an approximation of the response latency for communications between the computation module and the client. In one embodiment, the calculation module calculates the number of communication modules transceiving the packet using a “time to live” data field of the packet.

The association module associates the client with the computation module in response to the hop count satisfying a count range of a response policy. The response policy may specify a maximum acceptable response latency between the computation module and the client under one or more circumstances. In one embodiment, the count range specifies the maximum acceptable response latency when the association module is first attempting to associate the client with a first computation module. The apparatus manages response latency between the client and the computation module by associating the client to the computation module if the response latency between the client and the computation module complies with the response policy.

A system of the present invention is also presented to manage response latency. The system may be embodied in a client/server system such as a blade center. In particular, the system, in one embodiment, includes a client, a plurality of blade servers, a plurality of communication modules, an identification module, a calculation module, and an association module. In one embodiment, the system may further include a valid device module, an address module, and a security module.

The client may be a computer workstation, a terminal, a server, a mainframe computer, or the like. The client communicates with each blade server through one or more communication modules. Each blade server may execute one or more software processes for the client.

In one embodiment, the valid device module maintains a list of valid communication module addresses. The identification module identifies a first blade server. The calculation module calculates the number of communication modules that transceive a packet between the first blade server and the client as a hop count. In one embodiment, the address module records the address of each communication module transceiving the packet.

The association module associates the client with the first blade server in response to the hop count satisfying a count range of a response policy. If the hop count does not satisfy the count range, the association module may associate the client with the first blade server in response to the hop count satisfying an extended count range of the response policy and the client not being associated with a second blade server during a previous association attempt.

In one embodiment, the security module may block associating the client to the first blade server in response to the client communicating with the first blade server through an invalid communication module. The system manages the response latency of a client associating with a blade server and guards against an unauthorized client associating with the blade server by checking for communications through invalid communication modules.

A method of the present invention is also presented for managing response latency. The method in the disclosed embodiments substantially includes the steps necessary to carry out the functions presented above with respect to the operation of the described apparatus and system. In one embodiment, the method includes identifying a computation module, calculating the number of communications module that transceiver a packet, and associating the client. The method also may include generating a trouble ticket.

An identification module identifies a computation module. A calculation module calculates the number of communication modules that transceive a packet between the computation module and a client as a hop count. An association module associates the client with the computation module in response to the hop count satisfying a count range of a response policy. In one embodiment, a trouble ticket module generates a trouble ticket in response to a specified number of clients having a hop count greater than the count range. The method manages the response latency for a client such that the computation module provides acceptable service to the client.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention calculates a hop count between a client and a computation module and associates the client with the computation module in response to the hop count satisfying a count range of a response policy. In addition, the present invention blocks associating the client with the computation module when the response latency between the client and the computation module exceeds the count range or when the client communicates with the computation module through an invalid communication module. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a client/server system in accordance with the present invention;

FIG. 2 is a schematic block diagram illustrating one embodiment of a response latency management apparatus of the present invention;

FIG. 3 is a schematic block diagram illustrating one embodiment of a client/blade server system in accordance with the present invention;

FIG. 4 is a schematic block diagram illustrating one embodiment of a blade server in accordance with the present invention;

FIG. 5 is a schematic flow chart diagram illustrating one embodiment of a response latency management method of the present invention;

FIG. 6 is a schematic flow chart diagram illustrating one embodiment of a trouble ticket generation method of the present invention; and

FIG. 7 is a schematic block diagram illustrating one embodiment of a packet in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

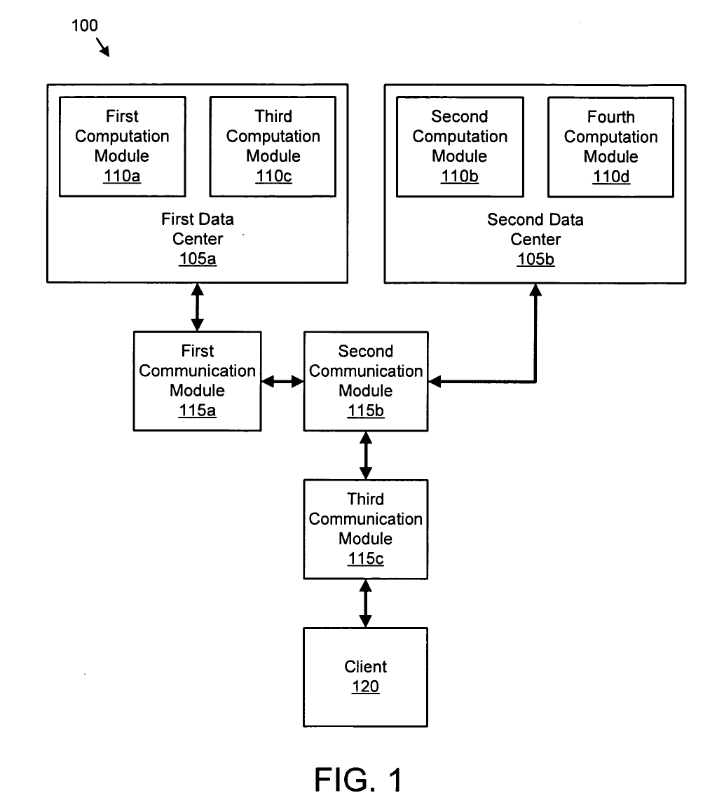

FIG. 1 is a schematic block diagram illustrating one embodiment of a client/server system 100 in accordance with the present invention. The system 100 includes one or more data centers 105, one or more communication modules 115, and a client 120. In addition, each data center 105 includes one or more computation modules 110. Although for simplicity the system 100 is depicted with two data centers 105, three communication modules 115, and one client 120, any number of data centers 105, communication modules 115, and clients 120 may be employed. In addition, each data center 105 may include any number of computation modules 110.

The client 120 may be a terminal, a computer workstation, or the like. A user may employ the client 120. The client 120 may also perform a function without user input. The computation module 110 may be a server, a blade server, a mainframe computer, or the like. The computation module 110 is configured to execute one or more software processes for the client 120. For example, the computation module 110 may execute a data base program for the client 120. The computation module 110 may also execute all software processes for the client 120, such as a client 120 configured as terminal.

The client 120 and the computation module 110 communicate through one or more communication modules 115. Each communication module 115 may be a router, a switch, or the like. The communication modules 115 may be organized as a network. The client 120 and the computation module 110 communicate by transmitting a packet to a communication module 115. The packet includes a destination address indicating the final destination of the packet. The communication module 115 transceives the packet toward the final destination, either by communicating the packet directly to the destination or by communicating the packet to a communication module 115 in closer logical proximity to the final destination.

For example, the client 120 may communicate the packet to the third communication module 115c. The packet includes a destination address data field specifying the first computation module 110a as the final destination. The third communication module 115c transceives the packet to the second communication module 115b and the second communication module 115b transceives the packet to the first communication module 115a. The first communication module 115a then communicates the packet to the first computation module 110a.

The client 120 communicates a beacon to one or more data centers 105 requesting association with a computation module 110. The computation module 110 associated with the client 120 may execute software processes for the client 120. The data center 105 may identify a computation module 110 with spare processing bandwidth such that the computation module 110 could provide an acceptable level of computational service to the client 120.

Unfortunately, if the response latency between the computation module 110 and the client 120 is excessive, the identified computation module 110 may not provide an acceptable level of service to the client 120 even if the computation module 110 has sufficient processing bandwidth. For example, the user of the client 120 may experience long time lags between issuing an input such as a command or data at the client 120 and receiving a response from the computation module 110. Yet the expectation is for relatively short time lags between the input and the response.

Unfortunately, response latency may be difficult to measure. For example, response latency measurement methods have relied on synchronized clocks to measure response latency. In addition, the measured response latency may vary dramatically from instance to instance because of changes in the communication load of the communication modules 115 and the like.

In addition, an unauthorized client 120 may also attempt to associate with a computation module 110. If a data center 105 allows an unauthorized client 120 to associate with the computation module 110, valuable data and security in one or more data centers 105 may be severely compromised.

The system 100 manages the response latency for the computation module 110 associated with the client 120 using a repeatable response latency measure. In one embodiment, the system 100 also uses the information from managing response latency to block unauthorized clients 120 from associating with computation modules 110.

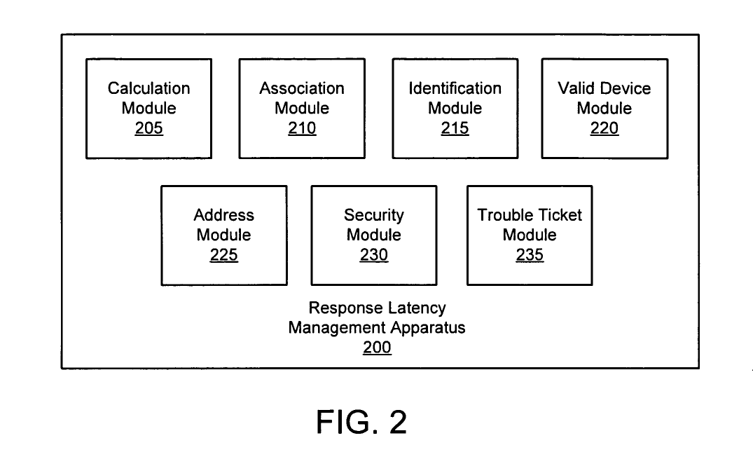

FIG. 2 is a schematic block diagram illustrating one embodiment of a response latency management apparatus 200 of the present invention. One or more computation modules 110 of FIG. 1 may comprise the apparatus 200. In the depicted embodiment, the apparatus 200 includes a calculation module 205, an association module 210, an identification module 215, a valid device module 220, an address module 225, a security module 230, and a trouble ticket module 235.

In one embodiment, the valid device module 220 maintains a list of valid communication module 110 addresses. The list may comprise a file assembled by an administrator wherein the address of each valid communication module 110 added to a network is also added to the file.

The identification module 215 identifies a first computation module 110a such as the first computation module 110a of FIG. 1. In one embodiment, the identification module 215 identifies the first computation module 110a in response to a request from a client 120 such as the client 120 of FIG. 1 for association with a computation module 110. The identification module 215 may identify the first computation module 110a as having sufficient spare processing bandwidth sufficient to support the client 120.

In one embodiment, the first computation module 110a has sufficient spare processing bandwidth if the first computation module 110a has a specified level of spare processing bandwidth. For example, the identification module 215 may identify the first computation module 110a if the first computation module 110a has eighty percent (80%) spare processing bandwidth. In an alternate embodiment, the first computation module 110a has sufficient spare processing bandwidth if the first computation module 110a is associated with a number of clients 120 less than a specified maximum. For example, the first computation module 110a may have sufficient spare processing bandwidth if associated with three (3) or fewer clients 120.

The calculation module 205 calculates the number of communication modules 115 such as the communication modules 115 of FIG. 1 that transceive a packet between the first computation module 110a and the client 120. The number of communication modules 115 transceiving the packet is a hop count. The hop count is an approximation of the response latency for communications between the computation module and the client. The calculation module 205 calculates the hop count from information included in the packet and does not require synchronized clocks or the like. In one embodiment, the calculation module calculates the number of communication modules transceiving the packet using a “time to live” data field of the packet. The hop count is also a reliable metric for response latency.

In one embodiment, the address module 225 records the address of each communication module 115 transceiving the packet. For example, if the client 120 of FIG. 1 communicated a packet to the first computation module 110a of FIG. 1, the address module 225 records the addresses of the third communication module 115c, the second communication module 115b, and the first communication module 115a.

The association module 210 associates the client 120 with the first computation module 110a if the hop count satisfies a response policy which may include a count range. The response policy may specify a maximum acceptable response latency as measured by a hop count between the computation module and the client under one or more circumstances. For example, the count range may be the value four (4), indicating the acceptable number of communication modules 115 transceiving packets communicated between the client 120 and the first computation module 110a is zero to four (0-4) communication modules 115.

For example, for a response policy with a count range of four (4), the identification module 215 may identify the first computation module 110a for association with the client 120. The calculation module 205 may calculate the hop count as three (3), because a packet communicated between the client 120 and the first computation module 110a passes through three communication modules 115. The association module 210 may associate the client 120 with the first computation module 110a because the hop count of three (3) satisfies the count range of four (4).

In one embodiment, the count range specifies the maximum acceptable response latency when the association module 210 is attempting to associate the client 120 with a computation module 110 for the first time. The association module 210 may also associate the client 120 with the first computation module 110a if the hop count satisfies an extended count range of the response policy and if the client 120 was not associated with a second computation module 110b such as the second computation module 110b of FIG. 1 during a previous association attempt.

For example, for a response policy with a count range of two (2), the identification module 215 may identify the second computation module 110b of FIG. 1 in response to a request from the client 120 of FIG. 1 for association with a computation module 110. The calculation module 205 may calculate the hop count for communications between the client 120 and the second communication module 110b as two (2). Yet although the hop count satisfies the count range, the association module 210 may be unable to associate the client 120 with the second computation module 110b, because for example, the second computation module 110b may lack sufficient processing bandwidth.

The identification module 215 may subsequently identify the first computation module 110a for association with the client 120. The calculation module 205 calculates the hop count for communications between the client 120 and the first computation module 110a as three (3). If the response policy specifies an extended count range of six (6), the association module 210 may associate the client 120 with the first computation module 110a as the hop count of three (3) satisfies an extended count range of six (6) and as the client 120 was not associated with the second computation module 110b during the previous association attempt. Thus the apparatus 200 may associate the client 120 with a computation module 110 with a longer response latency when required by circumstances such as the heavy use of one or more data centers 105.

In one embodiment, the apparatus 200 periodically checks for a computation module 110 with an improved hop count for each client 120. If a computation module 110 with an improved hop count is identified, the apparatus 200 may migrate the client's 120 association to the improved hop count computation module 110.

In one embodiment, the trouble ticket module 235 generates a trouble ticket if a specified number of clients 120 have a hop count that do not satisfy the count range. For example, the trouble ticket module 235 may record each client 120 associated with a computation module 110 where the hop count does not satisfy the count range. The trouble ticket module 235 compares the number of recorded clients 120 with a specified number such as thirty (30). If the number of recorded clients 120 exceeds the specified number of r thirty (30) clients 120, the trouble ticket module 235 generates a trouble ticket and may communicate the trouble ticket to an administrator or software process. The administrator or software process may reconfigure one or more system 100 elements in response to the trouble ticket. For example, the administrator may add a computation module 110 to a data center 105.

In one embodiment, the security module 230 blocks associating the client 120 to the first computation module 110a in response to the client 120 communicating with the first computation module 110a through an invalid communication module 115. The security module 230 may use the communication module 115 addresses recorded by the address module 225 to identify the invalid communication module 115. For example, an unauthorized client 120 may communicate through the third communication module 115c of FIG. 1. If the third communication module 115c address is not on the list of valid communication module 110 addresses maintained by the valid device module 220, the security module 230 may identify the third communication module 115c address recorded by the address module 225 as invalid and block associating the unauthorized client 120 to a computation module 110. The apparatus 200 manages the response latency of clients 120 associating with computation modules 110 and guards against unauthorized clients 120 associating with the computation modules 110 by checking for communications through invalid communication modules 115.

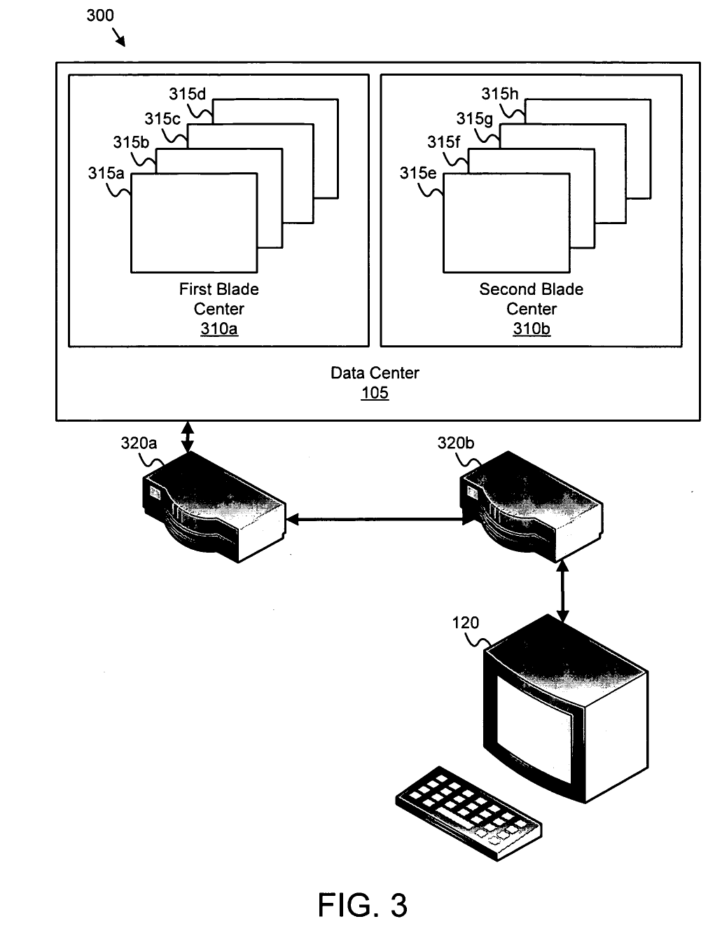

FIG. 3 is a schematic block diagram illustrating one embodiment of a client/blade server system 300 in accordance with the present invention. The system 300 may be one embodiment of the system 100 of FIG. 1. As depicted, the system 300 includes a data center 105, one or more routers 320, and a client 120. The data center 105 includes one or more blade centers 310, each comprising one or more blade servers 315.

The blade center 310 may be a rack-mounted enclosure with connections for a plurality of blade servers 315. In addition, the blade center 310 may include communication interfaces, interfaces to data storage systems, data storage devices, and the like. The blade center 310 may communicate with the data center 105 and the data center 105 may communicate with the routers 320.

The blade servers 315 may be configured as modular servers. Each blade server 315 may communicate through the blade center 310, the data center 105, and the routers 320 with the client 120. Each blade server 315 may provide computational services for one or more clients 120.

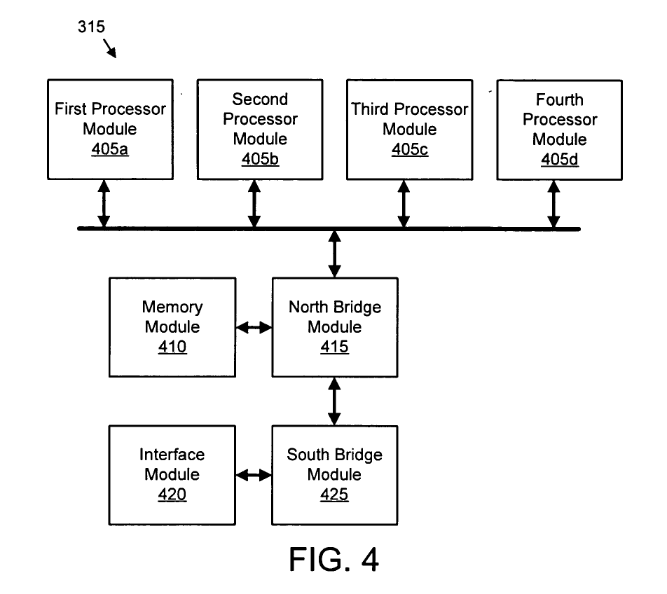

FIG. 4 is a schematic block diagram illustrating one embodiment of a blade server 315 in accordance with the present invention. The blade server 315 may include one or more processor modules 405, a memory module 410, a north bridge module 415, an interface module 420, and a south bridge module 425. Although the blade server 315 is depicted with four processor modules 405, the blade server 315 may employ any number of processor modules 405.

The processor module 405, memory module 410, north bridge module 415, interface module 420, and south bridge module 425, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate to substrate wiring, or circuit card traces or wires connecting the semiconductor devices.

The memory module 410 stores software instructions and data. The processor module 405 executes the software instructions and manipulates the data as is well know to those skilled in the art. In one embodiment, the memory module 410 stores and the processor module 405 executes software instructions and data comprising the calculation module 205, the association module 210, the identification module 215, the valid device module 220, the address module 225, the security module 230, and the trouble ticket module 235 of FIG. 2.

The processor module 405 may communicate with a computation module 110 or a client 120 such as the computation module 110 and client 120 of FIG. 1 through the north bridge module 415, the south bridge module 425, and the interface module 420. For example, the processor module 405 executing the identification module 215 may identify a first computation module 110a by querying the spare processing bandwidth of one or more computation modules 110 through the interface module 420. The processor module 405 executing the calculation module 205 may calculate a hop count by reading a “time to live” data field of a packet received from a client 120 through the interface module 420 and by subtracting the value of the “time to live” data field from a know value such as a standard initial “time to live” data field value as will be explained hereafter. In a certain embodiment, the processor module 405 executing the association module 210 associates the client 120 with the first computation module 110a by communicating with the client 120 and the computation module 110a through the interface module 420.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

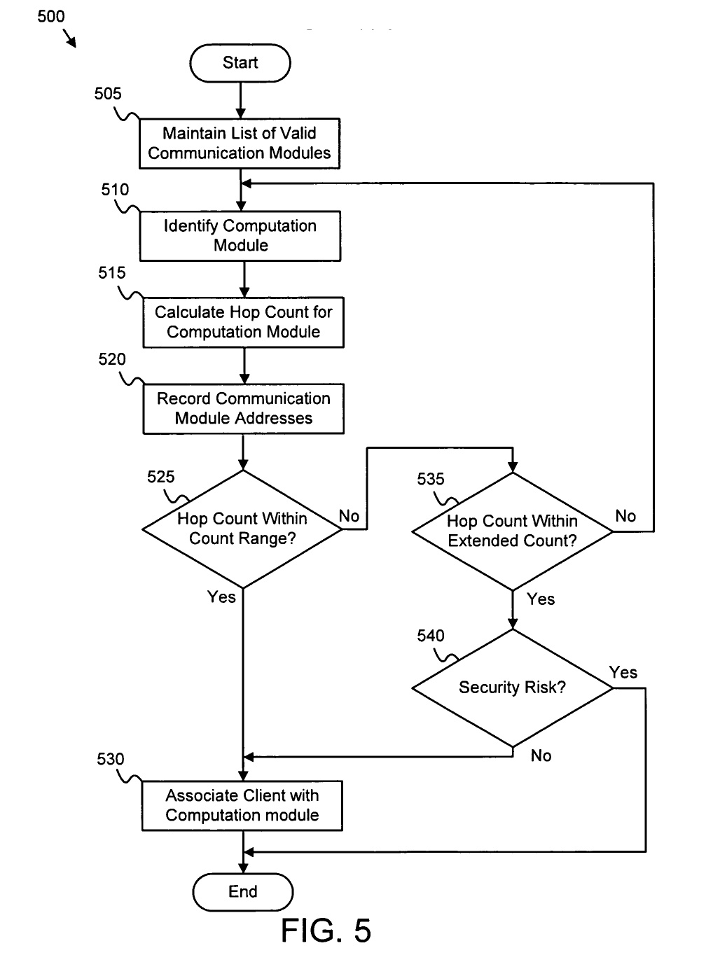

FIG. 5 is a schematic flow chart diagram illustrating one embodiment of a response latency management method 500 of the present invention. The method 500 substantially includes the steps necessary to carry out the functions presented above with respect to the operation of the described systems 100, 300 of FIGS. 1 and 3 and apparatus 200 of FIG. 2.

In one embodiment, the method 500 begins and a valid device module 220 such as the valid device module 220 of FIG. 2 maintains 505 a list of valid communication module 115 addresses. In a certain embodiment, the valid device module 220 maintains 505 the list from one or more configuration files recording communication module 115 address such as the addresses of the communication modules 115 of FIG. 1 in use by one or more portions of a network. The list may be organized as linked arrays of data fields, with each array of data fields comprising a valid communication module 115 address.

An identification module 215 such as the identification module 215 of FIG. 2 identifies 510 a first computation module 110a such as the first computation module 110a of FIG. 1. In a certain embodiment, the identification module 215 identifies 510 the first computation module 110a in response to a beacon from a client 120 such as the client 120 of FIG. 1 requesting association with a computation module 110. In one embodiment, the identification module 215 queries the available spare processing bandwidth for one or more computation modules 110 and identifies the first computation module 110a as having sufficient spare processing bandwidth to execute a software process for the client 120.

A calculation module 205 such as the calculation module 205 of FIG. 2 calculates 515 the number of communication modules 115 that transceive a packet between the first computation module 110a and the client 120 as a hop count. In one embodiment, the calculation module 205 calculates 515 the hop count using a “time to live” data field of the packet.

The “time to live” data field prevents a packet such as an invalid packet from being transceived indefinitely over a network. A sending device such as a computation module 110 or a client 120 may set the “time to live” data field to a specified initial value such as twenty (20) when the packet is originally transmitted. Each communication module 115 that transceives the packet may then decrement the “time to live” data field by a specified value such as one. A communication module 115 may delete the packet when the packet's “time to live” data field value is decremented to zero (0).

The calculation module 205 may calculate 515 the hop count as the specified initial “time to live” data field value minus the value of the “time to live” data field when the packet reaches a destination address. For example, if the specified initial value of the “time to live” data field for a packet is ten (10) and the value of the “time to live” data field is four (4) when the packet arrives at a destination address such as the first computation module 110a, the calculation module 205 may calculate the hop count as six (6).

In one embodiment, an address module 225 records 520 the address of each communication module 115 transceiving the packet. For example, each communication module 115 transceiving the packet may append the communication module's 115 own address to the packet. The address module 225 may record 520 the address of each communication module 115 transceiving the packet from the addresses appended to the packet.

An association module 210 determines 525 if the hop count satisfies a count range of a response policy. For example, if the count range is fifteen (15) and the hop count is twelve (12), the hop count satisfies the count range. If the hope count satisfies the count range, the association module 210 associates 530 the first computation module 110a with the client 120. In one embodiment, the association module 210 associates 530 the first computation module 110a and the client 120 by spawning a software process in communication with the client 120 on the first computation module 110a. In a certain embodiment, determining 525 if the hop count satisfies the count range also includes a security check. For example, unauthorized clients 120 typically attempt to associate with a computation module 110 through many communication modules 115. Limiting the allowable hop count to the count range may prevent the association 530 of many invalid clients 120.

If the hop count does not satisfy the count range, the association module 210 may determine 535 if the hop count satisfies an extended count range of the response policy. In one embodiment, the association module 210 determines 535 the hop count satisfies the extended count range if the hop count satisfies the extended count range and if the client 120 is not associated with a second computation module 110b such as the second computation module 110b of FIG. 1 during a previous association attempt. For example, if the identification module 215 previously identified the second computation module 110b for association with the client 120 but the association module 210 did not associate the second computation module 110b with the client 120, the association module 210 may determine 535 the hop count satisfies the extended count range.

If the association module 210 determines 535 the hop count does not satisfy the extended count range, the identification module 215 may identify 510 a third computation module 110c. In one embodiment, if the hop count satisfies extended count range, a security module 230 determines 540 if associating the client 120 with the first computation module 110a is a security risk. Associating the client 120 with the first computation module 110a may be a security risk if the address module 225 recorded 520 the address of a communication module 115 that is not on the list of valid communication modules 115 maintained 505 by the valid device module 220.

If the security module 230 determines 540 that associating the first computation module 110a with the client 120 is a security risk, the method 500 terminates. If the security module 230 determines 540 that associating the first computation module 110a with the client 120 is not a security risk, the association module 210 associates 530 the client 120 with the first computation module 110a. The method 500 manages the response latency of clients 120 associating with computation modules 110 using a hop count as a measure of response latency.

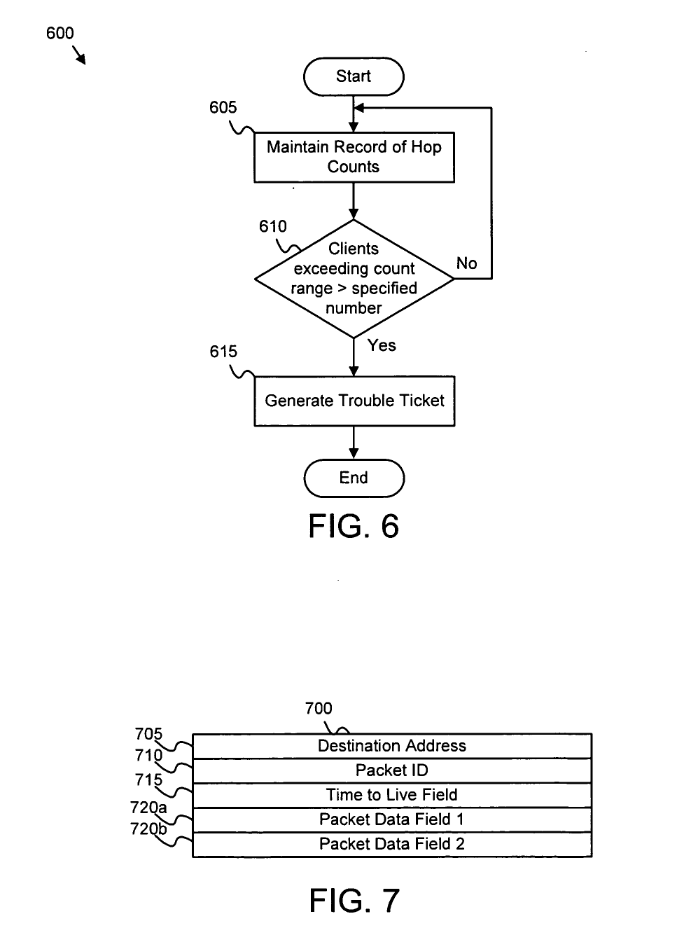

FIG. 6 is a schematic flow chart diagram illustrating one embodiment of a trouble ticket generation method 600 of the present invention. The method 600 substantially includes the steps necessary to carry out the functions presented above with respect to the operation of the described apparatus 200 of FIG. 2.

In one embodiment, a trouble ticket 235 module such as the trouble ticket module 235 of FIG. 2 maintains 605 a record of the hop count for each client 120 such as the client 120 of FIG. 1 associated to a computation module 110 such as the computation module 110 of FIG. 1. The trouble ticket module 235 may further determine 610 if the clients 120 associated to computation modules 110 with a hop count not satisfying the count range exceeds a specified number. If the clients 120 with a hop count not satisfying the count range exceed the specified number, the trouble ticket module 235 generates 615 a trouble ticket. In one embodiment, the trouble ticket notifies an administrator so that the administrator may take actions to reduce the response latency for clients 120. If the clients 120 with a hop count not satisfying the count range do not exceed the specified number, the trouble ticket module 235 continues to maintain 605 the record of hop counts for each client 120 associated 530 with a computation module 110. The method 600 generates 615 a trouble ticket so that an administrator may take corrective action to improve response latencies.

FIG. 7 is a schematic block diagram illustrating one embodiment of a packet 700 in accordance with the present invention. The packet 700 may be the packet communicated between clients 120, computation modules 110, and communications modules 115 in FIG. 1. In one embodiment, the packet 700 includes a destination address data field 705. The destination address data field 705 may comprise the logical address of a device such as the client 120 of FIG. 1 or the computation module 110 of FIG. 1. The packet 700 may also include a packet identification (“ID”) data field 710 that identifies the packet 700.

In one embodiment, the packet 700 includes a “time to live” data field 715. The “time to live” data field 715 may be set to a specified initial value such as forty (40). Each device such as a communication module 115 that transceives the packet 700 may decrement the “time to live” data field 715 value. For example, a communication module 115 receiving a packet 700 with a “time to live” data field 715 value of five (5) may transmit the packet 700 with a “time to live” data field 715 value of four (4). The packet 700 may also include other data fields 720. Although two other data fields 720 are depicted, any number of other data fields 720 may be employed. The other data fields 720 may include the data exchanged between the client 120 and the computation module 110. In one embodiment, the packet 700 conforms to a hypertext transfer protocol (“HTTP”) specification.

The present invention calculates 515 a hop count between a client 120 and a computation module 110 and associates 530 the client 120 with the computation module 110 in response to the hop count satisfying a count range. In addition, the present invention blocks associating the client 120 with the computation module 110 when the hop count between the client 120 and the computation module 110 does not satisfy the count range or when the client 120 communicates with the computation module 110 through an invalid communication module 115.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to manage response latency, the apparatus comprising:
an identification module configured to identify a first computation module;
a calculation module configured to calculate the number of communication modules that transceive a packet between the first computation module and a client as a hop count; and
an association module configured to associate the client with the first computation module in response to the hop count satisfying a count range of a response policy.

2. The apparatus of claim 1, wherein the association module is further configured to associate the client with the first computation module in response to the hop count satisfying an extended count range of the response policy.

3. The apparatus of claim 2, wherein the association module is further configured to associate the client with the first computation module in response to the client not being associated with a second computation module during a previous association attempt.

4. The apparatus of claim 1, further comprising a valid device module configured to maintain a list of valid communication module addresses.

5. The apparatus of claim 4, further comprising an address module configured to record the address of each communication module transceiving the packet.

6. The apparatus of claim 5, further comprising a security module configured to block associating the client with the first computation module in response to the client communicating with the first computation module through an invalid communication module.

7. The apparatus of claim 1, further comprising a trouble ticket module configured to generate a trouble ticket in response to a specified number of clients having a hop count greater than the count range.

8. The apparatus of claim 1, wherein the first computation module is configured as a blade server.

9. A signal bearing medium tangibly embodying a program of machine-readable instructions executable by a digital processing apparatus to perform operations to manage response latency, the operations comprising:
identifying a first computation module;
maintaining a list of valid communication module addresses;
calculating the number of communication modules that transceive a packet between the first computation module and a client as a hop count; and
associating the client with the first computation module in response to the hop count satisfying a count range of a response policy.

10. The signal bearing medium of claim 9, wherein the instructions further comprise an operation to associate the client with the first computation module in response to the hop count satisfying an extended count range of the response policy.

11. The signal bearing medium of claim 10, wherein the instructions further comprise an operation to associate the client with the first computation module in response to the client not being associated with a second computation module during a previous association attempt.

12. The signal bearing medium of claim 9, wherein the instructions further comprise an operation to record the address of each communication module transceiving the packet.

13. The signal bearing medium of claim 12, wherein the instructions further comprise an operation to block associating the client with the first computation module in response to the client communicating with the first computation module through an invalid communication module.

14. The signal bearing medium of claim 9, wherein the instructions further comprise an operation to generate a trouble ticket in response to a specified number of clients having a hop count greater than the count range.

15. The signal bearing medium of claim 9, wherein the first computation module is configured as a blade server.

16. A system to manage response latency, the system comprising:
a client;
a plurality of blade servers each configured to execute a software process for the client;
a plurality of communication modules configured to transceive a packet between the client and a blade server;
an identification module configured to identify a first blade server;
a calculation module configured to calculate the number of communication modules that transceive the packet between the first blade server and the client as a hop count; and
an association module configured to associate the client with the first blade server in response to the hop count satisfying a count range of a response policy and in response to the hop count satisfying an extended count range of the response policy and the client not being associated with a second blade server during a previous association attempt.

17. The system of claim 16, further comprising a valid device module configured to maintain a list of valid communication module addresses, an address module configured to record the address of each communication module transceiving the packet, and a security module configured to block associating the client with the first blade server in response to the client communicating with the first blade server through an invalid communication module.

18. The system of claim 16, further comprising a trouble ticket module configured to generate a trouble ticket in response to a specified number of clients having a hop count greater than the count range.

19. A method for deploying computer infrastructure, comprising integrating computer-readable code into a computing system, wherein the code in combination with the computing system is capable of performing the following:
maintaining a list of valid communication module addresses;
identifying a first computation module;
calculating the number of communication modules that transceive a packet between the first computation module and a client as a hop count;
associating the client with the first computation module in response to the hop count satisfying a count range of a response policy;
associating the client with the first computation module in response to the hop count satisfying an extended count range and in response to the client not being associated with a second computation module during a previous association attempt; and
generating a trouble ticket in response to a specified number of clients having a hop count greater than the count range.

20. The method of claim 19, further comprising recording the address of each communication module transceiving the packet and blocking associating the client with the first computation module in response to the client communicating with the first computation module through an invalid communication module.
